(19) United States
(12) Patent Application Publication
(10) Pub. No.: US 2012/0032844 A1
(43) Pub. Date: Feb. 9, 2012

(54) REAL-TIME LOCATION TRACKING APPARATUS AND METHOD USING GLOBAL POSITIONING SYSTEM (GPS) SIGNAL RELAY TAG

(75) Inventors: Sang Hyun Mo, Daejeon (KR); Heyung Sub Lee, Daejeon (KR); Jae Heum Lee, Daejeon (KR); Cheol Sig Pyo, Daejeon (KR); Kang Bok Lee, Daejeon (KR); Dong Beom Shin, Daejeon (KR); Seung Il Myong, Daejeon (KR); Joo Sang Park, Daejeon (KR); Hoe Sung Yang, Daejeon (KR); Jong Suk Chae, Daejeon (KR)

(73) Assignee: Electronics and Telecommunications Research institute, Daejeon (KR)

(21) Appl. No.: 13/195,391

(22) Filed: Aug. 1, 2011

(30) Foreign Application Priority Data
Aug. 3, 2010 (KR) 10-2010-0074989
Nov. 23, 2010 (KR) 10-2010-0116739

(51) Int. Cl. G01S 19/09

(52) U.S. Cl. 342/357.46

(57) ABSTRACT

Real-time location tracking apparatus and method using a global positioning system (GPS) signal relay tag is provided. Here, a tag may receive a GPS signal and transmit the received GPS signal to a reader, and the reader may calculate a location of the tag, and thereby a real-time location tracking service may be provided.

### CROSS-REFERENCE TO RELATED APPLICATIONS

This application claims the benefit of Korean Patent Application No. 10-2010-0074989 and of Korean Patent Application No. 10-2010-0116739, respectively filed on Aug. 3, 2010, and Nov. 23, 2010 in the Korean Intellectual Property Office, the disclosures of which are incorporated herein by reference.

### BACKGROUND

1. Field of the Invention

The present invention relates to a real-time location tracking apparatus and method using a global positioning system (GPS) signal relay tag, and more particularly, to an apparatus and method that may provide a real-time location tracking service to a user terminal using a location server, either by providing tag coordinates and tag information to the location server via a mobile communication network or the Internet after receiving a GPS signal from the GPS signal relay tag, transmitting GPS information and the tag information to the reader, and calculating, by the reader, a location of the tag, or by providing the tag coordinates and tag information to the location server after calculating, by a location processor, the location of the tag by receiving information necessary for the location calculation from the reader via the mobile communication network or the Internet, instead of performing the calculation by the reader.

2. Description of the Related Art

A global positioning system (GPS) was first developed for military application, and is now being used in various real world applications. In particular, the GPS is being used as a location-based service that may create new added value by merging location information of a user and periphery information through use of a mobile communication terminal such as, a smart phone. The location-based service may be used in various fields, such as a rescue request, a response to a reported crime, a geographical information system providing information of an adjacent area, and traffic information, a vehicle navigation system, logistics information, and the like.

A representative positioning method that may provide a location-based service using a GPS receiver mounted on a mobile communication terminal is classified into two schemes, Autonomous GPS and assisted GPS (A-GPS). The Autonomous GPS scheme refers to a scheme of positioning a location of a terminal autonomously in the terminal using a GPS reception antenna in the terminal and a positioning algorithm, without any assistance from a positioning server, and the like. A basic difference between the Autonomous GPS and the A-GPS is that the autonomous GPS communicates directly with a satellite using a GPS receiver in the terminal, whereas the A-GPS receives assistance from a mobile communication network or wireless fidelity (Wi-Fi) network, which is used in the mobile communication terminal. The A-GPS manages an assistance server including information regarding the closest GPS satellite for each region, which may perform communication, and constantly records satellite information. When the GPS terminal encounters difficulty in searching for a satellite signal, the satellite information may be received via the mobile communication network or the Wi-Fi network, and the assistance server may perform user location calculation and revision instead.

However, in order to independently calculate the location based on the GPS signal received using the Autonomous GPS, a separate CPU function should be equipped, and also a problem related to power consumption, such as a battery, in a cellular phone may need to be resolved. In the case of the A-GPS, information may be transferred and received via the mobile communication network or the Wi-Fi network, and accordingly a separate communication module, such as a mobile communication module, for example, long term evolution (LTE) second generation (2G), LTE third generation (3G), and the like, a WiFi module, and the like, may be required, which may result in a high terminal price. Accordingly, the A-GPS is generally applied to a smart phone. The location-based service using a mobile communication terminal is generally used as a service for providing location information of a user to the user, or a service for providing the location information of the user to another mobile communication terminal user, for example, a safe return service to report someone arriving safely at home to guardians.

The conventional location tracking system using a mobile communication terminal and a mobile communication network is applied to limited service areas, and only users who use an expensive terminal, and uses a great amount of power.

### SUMMARY

An aspect of the present invention provides a real-time location tracking apparatus using a global positioning system (GPS) signal relay tag, which may identify a location of a tag using low power, by relaying a GPS signal via a mobile communication network and the Internet.

Another aspect of the present invention also provides a real-time location tracking apparatus and method using a GPS signal relay tag, wherein a tag may output a transmission message frame to a reader by configuring the transmission message frame including identification (ID) information and a GPS signal when the tag is activated and receives the GPS signal, and the reader may receive the output signal of the tag, and may calculate a location of the tag based on the received signal of the tag.

Still another aspect of the present invention also provides a real-time location tracking apparatus and method using a GPS signal relay tag, wherein a reader may receive an output signal and a GPS signal of a tag, and may calculate a location of the tag based on time information and location data of the tag.

A yet another aspect of the present invention also provides a real-time location tracking apparatus and method using a GPS signal relay tag, wherein a tag may sense a state of surroundings, and may transmit a transmission message frame by incorporating the sensed information into the transmission message frame, and a reader may process the sensed information by receiving the transmission message frame.

Further another aspect of the present invention also provides a real-time location tracking apparatus and method using a GPS signal relay tag, wherein a tag may transmit a transmission message frame by encoding the transmission message frame, a reader may receive the encoded transmission message frame, and may extract information included in the transmission message frame by decoding the received transmission message frame.

Still another aspect of the present invention also provides a real-time location tracking apparatus and method using a GPS signal relay tag, wherein a condition under which a tag may be activated according to a predetermined condition may be determined, and the tag may transmit a transmission message frame when activated.

Still another aspect of the present invention also provides a real-time location tracking apparatus and method using a GPS signal relay tag, which may work conjunctively with a mobile communication network or the Internet by installing a reader in a mobile communication base station or relay station at an Access Point (AP).

Still another aspect of the present invention also provides a real-time location tracking apparatus and method using a GPS signal relay tag, wherein a reader may transmit, to a location processor, information regarding time information and location data stored in a transmission message frame of a tag via a mobile communication network or the Internet, and the location processor may calculate a location of the tag.

Still another aspect of the present invention provides a real-time location tracking apparatus and method using a GPS signal relay tag, wherein a location processor may calculate a location of a tag based on time information and location data, corresponding to the identical ID information of the tag, received from at least three satellites.

Still another aspect of the present invention provides a real-time location tracking apparatus and method using a GPS signal relay tag, wherein a reader may calculate a location of a tag based on information gathered by extracting the information regarding time information and location data stored in a transmission message frame of the tag.

Still another aspect of the present invention provides a real-time location tracking apparatus and method using a GPS signal relay tag, wherein a location server may provide a service associated with a location of a tag to a user terminal via a mobile communication network or the Internet.

Still another aspect of the present invention provides a real-time location tracking apparatus using a GPS signal relay tag, the apparatus including a tag, positioned in relation to an object, to work conjunctively with a GPS signal received from a satellite, to transmit the received GPS signal to a reader installed in a base station, a relay station, or an Access Point (AP), and to enable calculation of location coordinates of the object by the reader.

The tag may transmit, to the reader, ID information intrinsically assigned in advance, along with the GPS signal, thereby enabling matching of the object identified based on the ID information in the reader, with the location coordinates calculated based on the GPS signal.

The apparatus may further include a sensing unit to activate the tag when a measurement value of at least one of humidity, illuminance, and temperature around the tag satisfies a predetermined criterion value, and the tag may transmit the GPS signal to the reader when activated.

Still another aspect of the present invention provides a real-time location tracking apparatus using a GPS signal relay tag, the apparatus including a reader to receive a transmission message frame from a tag, and a GPS receiver to identify an object where the tag may be positioned, based on ID information extracted from the transmission message frame, and to match the object to location coordinates calculated based on a GPS signal extracted from the transmission message frame.

The GPS receiver may calculate the location coordinates by applying time information and location data of the tag in the GPS signal.

The GPS receiver may identify the time information and the location data from the GPS signal, and may provide the identified time information and the location data to a location processor via a mobile communication network and the Internet, and the location processor may calculate the location coordinates by applying the time information and the location data.

The GPS receiver may extract state information sensed in relation to the peripheral environment of the tag, from the transmission message frame, and may direct a state of the tag by processing the state information.

When the transmission message frame is encoded before transmitting, the apparatus may further include a decoding module to decode the encoded transmission message frame.

The reader may respectively receive n transmission message frames from n tags positioned in relation to the object, n being a natural number.

The apparatus may further include a database to store the location coordinates, and the corresponding object matched with the location coordinates, and the GPS receiver may provide, from the database, the location coordinates corresponding to an object of which inquiry may be requested, in response to the inquiry request for the object.

Still another aspect of the present invention provides a real-time location tracking method using a GPS signal relay tag, the method including receiving, by a tag, a GPS signal from a satellite, the tag being positioned in association with an object, and enabling calculation of location coordinates of the object in the reader, when the received GPS signal is transmitted by the tag, to the a base station or relay station including the reader, or an AR

The method may further include transmitting, by the tag, ID information associated with identifying of the object, along with the GPS signal, to the reader.

The method may further include activating the tag when a measured value of at least one of humidity, illuminance, and temperature around the tag satisfies a predetermined criterion value, and the transmitting may include transmitting the GPS signal to the reader when the tag is activated.

According to another aspect of the present invention, there is provided a real-time location tracking method using a GPS signal relay tag, the method including receiving a transmission message frame from a tag, extracting identification (ID) information from the transmission message frame, and identifying an object including the tag based on the extracted ID information, extracting GPS information from the transmission message frame, and obtaining location coordinates using the extracted GPS signal, and matching the obtained location coordinates and the identified object.

The obtaining may include calculating the location coordinates by applying time information and location data of the tag in the GPS signal.

The obtaining may include providing the time information and the location data of the tag to a location processor, by identifying the time information and the location data of the tag from the GPS signal, and receiving, by a location server, the location coordinates calculated by applying the time information and the location data, from the location processor.

The method may further include extracting state information sensed in relation to the peripheral environment of the tag, from the transmission message frame, and directing a state of the tag by processing the state information.

When the transmission message frame is encoded before transmitting, the method may further include decoding the encoded transmission message frame.

The receiving may include respectively receiving n transmission message frames from n tags positioned in relation to the object, n being a natural number.

The method may further include storing, in a database, the location coordinates, and the corresponding object matched with the location coordinates, and providing, by the location server, the location coordinates corresponding to an object of which inquiry is requested, in response to the inquiry request for the object.

### EFFECT

According to embodiments of the present invention, a global positioning system (GPS) signal may be transferred to a location processor by relaying the GPS signal using a GPS signal relay tag via a mobile communication network and the Internet, and a location of a tag may be calculated using low power through location calculation performed by the location processor. Thus, the tag may use a minimum amount of power, and the location processor may calculate the location of the tag.

According to embodiments of the present invention, a tag may be activated and may receive a GPS signal, configure a transmission message frame including identification (ID) information and the received GPS signal, and output the configured transmission message frame to a reader, and the reader may receive the output signal of the tag, and may calculate a location of the tag based on the received output signal of the tag. Thus, the tag may receive the GPS signal in an activation state, configure a transmission message frame, and transmit the transmission message frame to the reader, and the reader may calculate the location of the tag based on information included in the transmission message frame.

According to embodiments of the present invention, a reader may receive an output signal of a tag and a GPS signal, and may calculate a location of the tag based on time information and location data of the tag. Thus, the reader may receive information necessary for location calculation, and may calculate the location of the tag based on the received information.

According to embodiments of the present invention, a tag may sense a state of the peripheral environment, and may transmit a transmission message frame by incorporating the sensed information into the transmission message frame, and a reader may receive the transmission message frame of the tag, and may process the sensed information. Thus, the reader may collect and use the information regarding the peripheral environment of the tag.

According to embodiments of the present invention, a tag may transmit a transmission message frame by encoding the transmission message frame, and a reader may receive the transmitted message frame, and may extract information included in the transmission message frame by decoding the encoded transmission message frame. Thus, the tag may transmit the encoded data to the reader, and accordingly a data transmission channel with enhanced security between the tag and the reader may be configured.

According to embodiments of the present invention, a condition under which a tag may be activated according to a predetermined condition may be determined, and the tag may transmit a transmission message frame when activated. Thus, the tag may configure the transmission message frame, and may transmit the transmission message frame to the reader when the specific condition is satisfied, and accordingly may use a minimum power, and a battery equipped in the tag, having a limited capacity, may be used for a relatively long period of time.

According to embodiments of the present invention, a reader may transmit, to a location processor, information regarding time information and location data stored in a transmission message frame of a tag, via a mobile communication network or the Internet, and the location processor may calculate a location of the tag. Thus, the location processor may perform the task of calculating the location of the tag so that a location information service may be provided in a short time.

According to embodiments of the present invention, a location processor may calculate a location of a tag based on time information and location data received from at least three satellites, with respect to the identical ID information of the tag. Thus, an accuracy of the location calculation performed by the location processor may be improved.

According to embodiments of the present invention, a reader may extract information regarding time information and location data stored in a transmission message frame of a tag, and may calculate a location of the tag based on the extracted information. Thus, a high speed calculation function performed by the reader may be allocated and used for calculating the location of the tag.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a real-time location tracking apparatus using a global positioning system (GPS) signal relay tag according to an embodiment of the present invention;

FIG. 2 is a diagram illustrating a configuration of a GPS signal relay tag according to an embodiment of the present invention;

FIG. 3 is a flowchart illustrating an operational sequence of a GPS signal relay tag according to an embodiment of the present invention;

FIG. 4 is a function block diagram illustrating a security tag for a satellite relay and environment monitor according to an embodiment of the present invention;

FIG. 5 is a diagram illustrating a configuration of a GPS signal relay tag according to another embodiment of the present invention; and

FIG. 6 is a diagram illustrating a reader according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

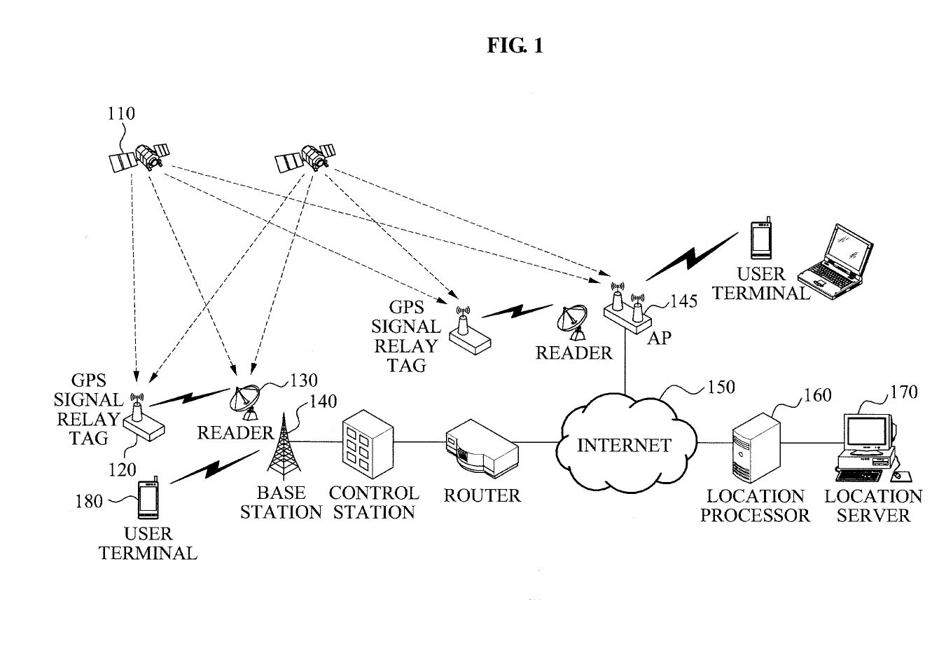

FIG. 1 is a diagram illustrating a configuration of a real-time location tracking apparatus using a global positioning system (GPS) signal relay tag according to an embodiment of the present invention.

Referring to FIG. 1, the apparatus may include a satellite 110, a GPS signal relay tag 120, a reader 130, a base station 140, an Access Point (AP) 145, the Internet 150, a location processor 160, a location server 170, and a user terminal 180.

The satellite 110 may periodically transmit a GPS signal including time information and location information of the satellite 110 at a point in time.

The GPS signal relay tag 120 may receive the GPS signal, and may allocate calculation of a location of a tag to the reader 130 that may be installed in the base station 140 or the AP 145, based on information included in the received GPS signal. The GPS signal relay tag 120 may transfer, to the reader 130, the time information and identification (ID) information received from the satellite 110, excluding location data included in the GPS signal, such as the location information of the satellite.

The reader 130 either may perform location calculation based on the information received from the GPS signal relay tag 120, or may transfer, to the location processor 160, the information received from the GPS signal relay tag 120 without calculating the location.

As an example, the reader 130 may calculate the location of the tag based on the location data extracted from the GPS signal using a GPS reception module, the time information received from the GPS signal relay tag 120, and the ID information of the tag. The location information of the tag calculated by the reader 130 may be transferred to the location processor 160 via a mobile communication network or the Internet 150. The location server 170 may access the location process 160, and may obtain the location information of the tag stored in a storage medium, thereby providing, to the user terminal 180, a location-based service corresponding to an applied field. The user terminal 180 may include wired and wireless communication devices, such as a cellular phone, a PC, a TV, and the like.

As another example, the reader 130 may receive the time information and the ID information from the GPS signal relay tag 120, and may transfer, to the location processor 160, the received information via a mobile communication network and the Internet 150. In this instance, the reader 130 may constantly transfer location data to the location processor 160 by extracting the location data from the GPS signal using the GPS reception module. The location processor 160 may calculate longitude and latitude coordinates of the tag based on the location data. The location server 170 may access the location process 160, and may obtain the location information of the tag stored in a storage medium, thereby providing, to the user terminal 180, a location-based service corresponding to an applied field, for example, property management, parking lot management, safe return of children to a home, patient management, and the like.

The user terminal 180 may monitor the location of the GPS signal relay tag 120 via a mobile communication network, and the Internet 150. When the user terminal 180 corresponds to a mobile communication terminal, the location information of the GPS signal relay tag 120, and additional data information may be received through communication with the base station 140. When the user terminal 180 corresponds to a wireless data terminal, such as WiBro, wireless fidelity (WiFi), Bluetooth, and the like, the location information of the GPS signal relay tag 120, and the additional data information may be received through a wireless data AP. When the user terminal 180 corresponds to a wired terminal, such as an Internet Protocol television (IPTV), the location information of the GPS signal relay tag 120, and the additional data information may be received through the wired Internet network.

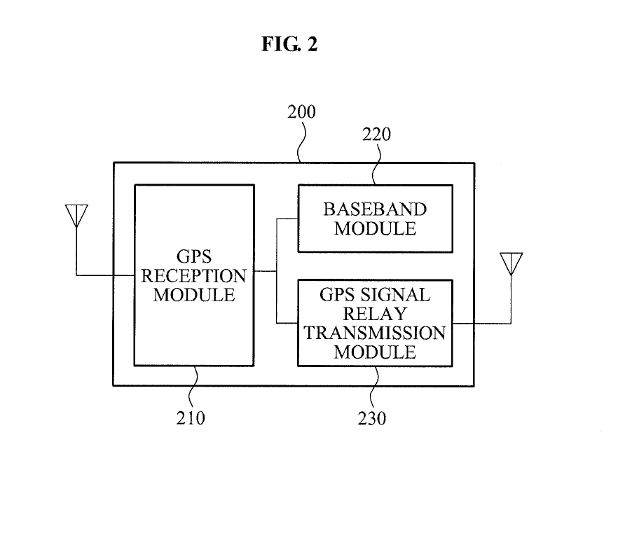

FIG. 2 is a diagram illustrating a configuration of a GPS signal relay tag 200 according to an embodiment of the present invention.

Referring to FIG. 2, the GPS signal relay tag 200 may include a GPS reception module 210, a baseband module 220, and a GPS signal relay transmission module 230.

The GPS reception module 210 may transmit, to the baseband module 220, time information obtained by decoding a GPS signal received from a satellite.

The baseband module 220 may generate a transmission message frame by incorporating the time information and location information of the satellite, received from the satellite, and ID information of the tag, and may perform an encoding task.

The GPS signal relay transmission module 230 may externally transmit a carrier frequency via an antenna by incorporating an encoding signal generated by the baseband module 220, and a Cyclic Redundancy Check (CRC) carrier wave into the carrier frequency.

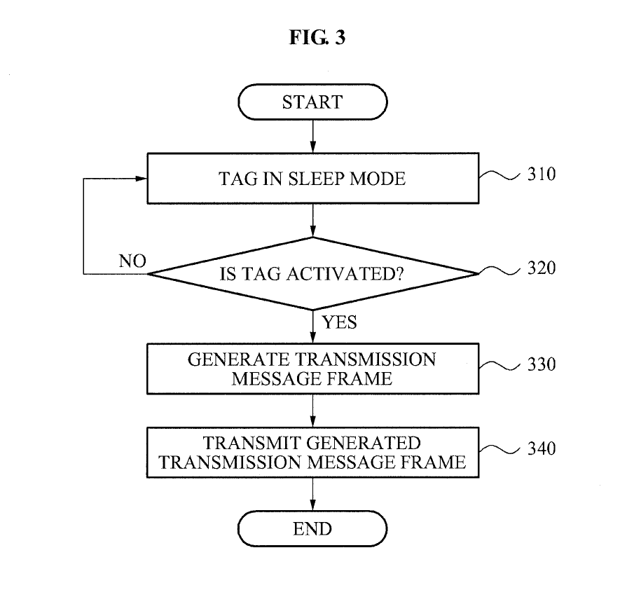

FIG. 3 is a flowchart illustrating an operational sequence of a GPS signal relay tag according to an embodiment of the present invention.

The method performed by the GPS signal relay tag may be configured by the GPS signal relay tag as described in the foregoing with reference to FIG. 2. The following description is provided to assist the reader in gaining a sufficient understanding of the present invention by providing the description with reference to FIG. 3, along with FIG. 2.

In operation 310, the GPS signal relay tag may be operated in a sleep mode for a majority of time, and accordingly may use a minimum power.

In operation 320, the GPS signal relay tag may be activated when the power is switched on, and may receive a GPS signal through a GPS reception module.

In operation 330, the GPS signal relay tag may operate a baseband module to generate a transmission message frame including ID information of the tag in addition to time information and location information of a satellite, included in the GPS signal received through the GPS reception module.

In operation 340, the GPS signal relay tag may operate a GPS signal relay transmission module to transmit the generated transmission message frame to a reader.

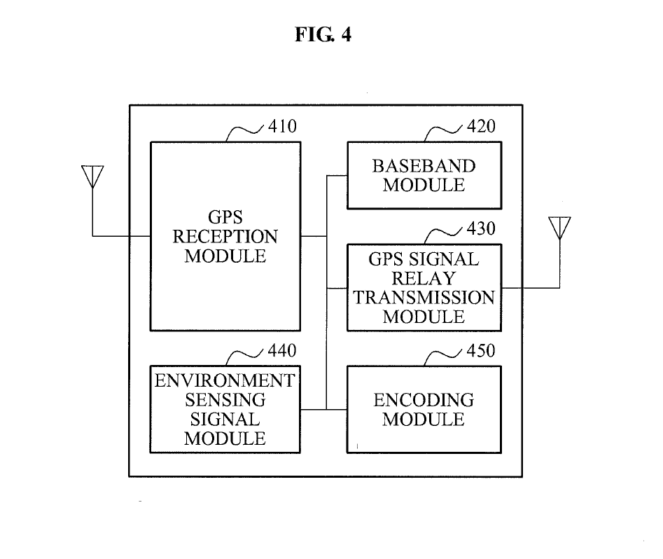

FIG. 4 is a function block diagram illustrating a security tag for a satellite relay and environment monitor according to an embodiment of the present invention.

The security tag of FIG. 4 may include a GPS reception module 410, a baseband module 420, and a GPS signal relay transmission module 430, which may have the same configuration, and perform the same functions of the GPS signal relay tag of FIG. 2. The security tag of FIG. 4 may further include an environment sensing signal module 440, and an encoding module 450 for performing additional functions.

The environment sensing signal module 440 may sense a state of the peripheral environment using a sensor, and may transmit corresponding data to the baseband module 420 by converting the sensed information into data. The baseband module 420 may include at least one of a humidity sensor, an illuminance sensor, and a temperature sensor in order to activate the tag according to a specific environmental condition, and may output the transmission message frame to the GPS signal relay transmission module 430 when the tag is activated. The GPS signal relay transmission module 430 may externally transmit a carrier frequency via an antenna by incorporating an encoding signal generated by the baseband module 420, and a CRC carrier wave into the carrier frequency.

The encoding module 450 may prevent an exposure of the transmission data by encoding the data to be transmitted before the GPS signal relay transmission module 430 transmits the data.

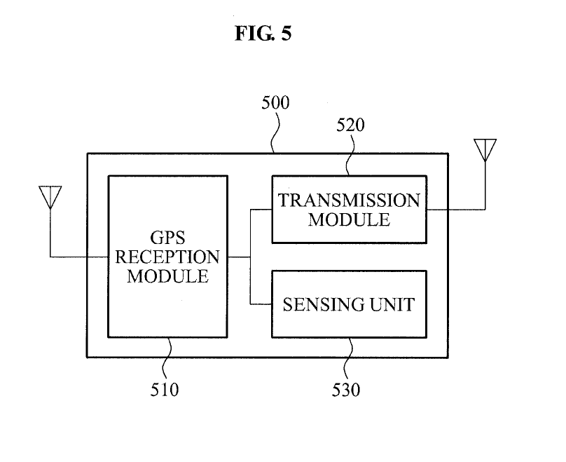

FIG. 5 is a diagram illustrating a configuration of a GPS signal relay tag 500 according to another embodiment of the present invention. The configuration and an operation of the GPS signal relay tag 500 will be described hereinafter.

The tag 500 may be positioned in relation to an object, and may receive a GPS signal from a satellite through a GPS reception module 510. The tag 500 may transmit the received GPS signal to a reader. The reader may calculate location coordinates of the object based on the GPS signal received from the tag 500.

The tag 500 may transmit the received GPS signal, and ID information intrinsically assigned in advance, to the reader through a transmission module 520. The reader may match the object identified based on the ID information, and the location coordinates calculated based on the GPS signal.

The tag 500 may operate a sensing unit 530 to switch to an active mode when a measurement value of at least one of humidity, illuminance, and temperature around the tag 500 satisfies a predetermined criterion value. The tag 500 may transmit the GPS signal to the reader when a sleep mode is switched to the active mode. The reader may calculate the location coordinates of the object based on the received GPS signal.

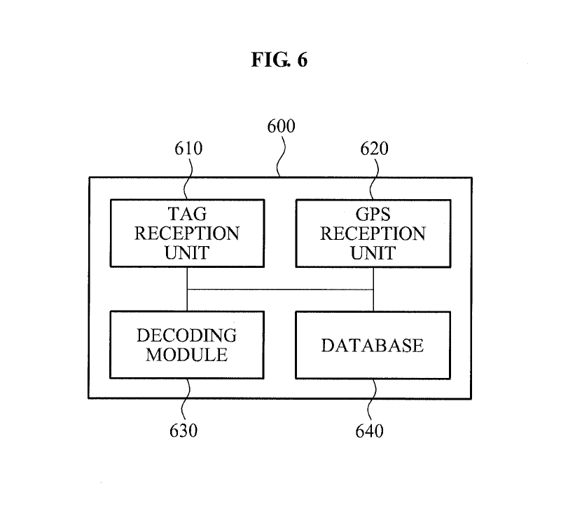

FIG. 6 is a diagram illustrating a reader 600 according to an embodiment of the present invention. The configuration of the reader 600, and operations of each element of the reader 600 will be described hereinafter. Referring to FIG. 6, the reader 600 may include a tag reception unit 610, a GPS reception unit 620, a decoding module 630, and a database 640.

The tag reception unit 610 may receive, from a tag, a transmission message frame including a GPS signal and ID information. The tag reception unit 610 may transfer, to the GPS reception unit 620, the transmission message frame received from the tag.

The GPS reception unit 620 may identify an object where the tag may be positioned, based on the ID information extracted from the transmission message frame, and may match the object and location coordinates calculated based on the GPS signal extracted from the transmission message frame.

As an example, the GPS reception unit 620 may calculate the location coordinates by applying time information and location data of the tag for the GPS signal, received by the tag, included in the transmission message frame.

As another example, the location coordinates of the tag may be calculated by a location processor, instead of the GPS reception unit 620. The GPS reception unit 620 may identify the time information and the location data of the tag from the GPS signal, and may provide the identified time information and location data to the location processor. The location processor may calculate the location coordinates of the tag based on the time information and the location data received from the GPS reception unit 620, and may provide the calculated location coordinates to the GPS reception unit 620.

The tag may transfer, to the reader 600, a transmission message frame by incorporating state information sensed in relation to the peripheral environment, into the transmission message frame. The GPS reception unit 620 of the reader 600 may extract the information sensed in relation to the peripheral environment from the transmission message frame, and may processing the state information to report a state of the tag.

When an encoded transmission message frame is received from the tag, the reader 600 may decode the encoded transmission message frame through the decoding module 630. The reader 600 may calculate the location coordinates of the tag based on the GPS signal of the tag, included in the decoded transmission message frame.

The tag reception unit 610 may respectively receive transmission message frames from a plurality of tags positioned in relation to objects. The tag reception unit 610 may receive the plurality of transmission message frames from the tags, and may transfer the plurality of transmission message frames to the GPS reception unit 620. Here, the GPS reception unit 620 may calculate locations of the tags based on GPS signals received by each of the tags, included in the plurality of transmission message frames.

The GPS reception unit 620 may store the calculated locations of the tags, and the corresponding objects in the database 640. The GPS reception unit 620 may provide, from the database, location coordinates corresponding to the objects of which inquiries may be requested, in response to the inquiry requests for the objects.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A real-time location tracking apparatus using a global positioning system (GPS) signal relay tag, the apparatus comprising:
a tag, positioned in relation to an object, to work conjunctively with a GPS signal received from a satellite, to transmit the received GPS signal to a reader installed in a base station, a relay station, or an Access Point (AP), and to enable calculation of location coordinates of the object by the reader.

2. The apparatus of claim 1, wherein the tag transmits, to the reader, identification (ID) information intrinsically assigned in advance, along with the GPS signal, thereby enabling matching of the object identified based on the ID information in the reader, with the location coordinates calculated based on the GPS signal.

3. The apparatus of claim 1, further comprising:
a sensing unit to activate the tag when a measurement value of at least one of humidity, illuminance, and temperature around the tag satisfies a predetermined criterion value,
wherein the tag transmits the GPS signal to the reader when activated.

4. A real-time location tracking apparatus using a global positioning system (GPS) signal relay tag, the apparatus comprising:
a reader to receive a transmission message frame from a tag; and
a GPS receiver to identify an object where the tag is positioned, based on identification (ID) information extracted from the transmission message frame, and to match the object to location coordinates calculated based on a GPS signal extracted from the transmission message frame.

5. The apparatus of claim 4, wherein the GPS receiver calculates the location coordinates by applying time information and location data of the tag in the GPS signal.

6. The apparatus of claim 4, wherein
the GPS receiver identifies the time information and the location data from the GPS signal, and provides the identified time information and the location data to a location processor via a mobile communication network and the Internet, and
the location processor calculates the location coordinates by applying the time information and the location data.

7. The apparatus of claim 4, wherein the GPS receiver extracts state information sensed in relation to the peripheral environment of the tag, from the transmission message frame, and directs a state of the tag by processing the state information.

8. The apparatus of claim 4, wherein the reader respectively receives n transmission message frames from n tags positioned in relation to the object, n being a natural number.

9. The apparatus of claim 4, further comprising:
a database to store the location coordinates, and the corresponding object matched with the location coordinates,
wherein the GPS receiver provides, from the database, the location coordinates corresponding to an object of which inquiry is requested, in response to the inquiry request for the object.

10. A real-time location tracking method using a global positioning system (GPS) signal relay tag, the method comprising:
receiving, by a tag, a GPS signal from a satellite, the tag being positioned in relation to an object; and
enabling calculation of location coordinates of the object by the reader, when received GPS signal is transmitted to the reader, by the tag.

11. The method of claim 10, further comprising:
transmitting, by the tag, identification (ID) information associated with identifying of the object, along with the GPS signal, to the reader.

12. The method of claim 10, further comprising:
activating the tag when a measurement value of at least one of humidity, illuminance, and temperature around the tag satisfies a predetermined criterion value,
wherein the transmitting comprises transmitting the GPS signal to the reader when the tag is activated.

13. A real-time location tracking method using a global positioning system (GPS) signal relay tag, the method comprising:
receiving a transmission message frame from a tag;
extracting identification (ID) information from the transmission message frame, and identifying an object including the tag based on the extracted ID information;
extracting GPS information from the transmission message frame, and obtaining location coordinates using the extracted GPS signal; and
matching the obtained location coordinates and the identified object.

14. The method of claim 13, wherein the obtaining comprises calculating the location coordinates by applying time information and location data of the tag in the GPS signal.

15. The method of claim 13, wherein the obtaining comprises:
providing the time information and the location data of the tag to a location processor, by identifying the time information and the location data of the tag from the GPS signal; and
receiving, by a location server, the location coordinates calculated by applying the time information and the location data, from the location processor.

16. The method of claim 13, further comprising:
extracting state information sensed in relation to the peripheral environment of the tag, from the transmission message frame; and
directing a state of the tag by processing the state information.

17. The method of claim 13, wherein the receiving comprises respectively receiving n transmission message frames from n tags positioned in relation to the object, n being a natural number.

18. The method of claim 13, further comprising:
storing the location coordinates, and the corresponding object matched with the location coordinates, in a location server; and
providing, by the location server, the location coordinates corresponding to an object of which inquiry is requested, in response to the inquiry request for the object.

19. The method of claim 18, wherein a user terminal, which requests a location-based service to a location server, and receives the location-based service from the location server, includes a wireless data terminal, for example, a cellular phone, WiBro, wireless fidelity (WiFi), Bluetooth, and the like, and a wired data terminal, for example, an Internet Protocol television (IPTV), and the like.

20. The method of claim 18, further comprising:
responding, by the location server, to the user terminal through a mobile communication network and a base station, or responding, by the location server, to the user terminal through the Internet and an Access Point (AP), in accordance with a request from the user terminal.
